(19) United States
(12) Patent Application Publication
(10) Pub. No.: US 2026/0155142 A1
(43) Pub. Date: Jun. 4, 2026

(54) KEYWORD-BASED DEVICE ACTIVATION TO AVOID FALSE POSITIVES

(71) Applicant: Advanced Micro Devices, Inc., Santa Clara, CA (US)

(72) Inventor: Vasuki Soni, Korba (IN)

(73) Assignee: Advanced Micro Devices, Inc., Santa Clara, CA (US)

(21) Appl. No.: 18/964,029

(22) Filed: Nov. 29, 2024

(51) Int. Cl. G10L 15/22; G06T 7/70; G10L 15/08; G10L 15/28

(52) U.S. Cl. CPC G10L 15/22; G06T 7/70; G10L 15/08; G10L 15/28; G06T 2207/10024; G06T 2207/10048; G06T 2207/30201; G10L 2015/088; G10L 2015/223

(57) ABSTRACT

Keyword-based device activation to avoid false positives includes detecting, by a hardware processor of a device, a first user utterance specifying a first keyword of a multi-keyword phrase from audio data. In response to detecting the first user utterance, the audio data is monitored by the processor for a second user utterance specifying a second keyword of the multi-keyword phrase, and sensor data generated by a user attention sensor of the device is monitored for an indication of user attention directed to the device. In response to detecting the second keyword and detecting the indication of user attention directed to the device, a selected operation of the device is initiated by the hardware processor.

### TECHNICAL FIELD

This disclosure relates to keyword-based device activation and avoiding false positives.

### BACKGROUND

A variety of different types of devices implement a feature referred to as “keyword spotting.” keyword spotting is a technology that allows a device to respond to a user utterance that specifies a particular keyword. With this feature enabled, the device continuously receives sound via a microphone. The device continuously analyzes the sound to detect the keyword in user speech. Once the keyword is detected by the device, the device responds by implementing a particular operation or function. Keyword spotting enables at least a certain degree of hands-free operation of the device.

There are situations in which a device with keyword spotting enabled may detect or respond to false positives. A false positive occurs in cases where a device correctly detects the keyword uttered by the user, but the user intended to interact with a different device than the one responding to the keyword. Consider the case in which the user is located in a room with multiple devices each with keyword spotting enabled where the keyword is the same for each device. The user may utter the keyword thereby causing each of the devices to respond despite the user intending to interact with only one of the devices.

This situation may cause duplicative and/or erroneous operations to be performed by one or more of the devices with which the user did not intend to interact referred to herein as “unintended devices.” This situation may also unnecessarily increase power consumption of the unintended device(s) particularly in the case where the unintended device(s) exit a low power operating state in response to the detected keyword. These issues may be exacerbated in cases where even more devices that use a same keyword and have keyword spotting enabled are co-located with the user.

### SUMMARY

In one or more examples, a method includes detecting, by a hardware processor of a device, a first user utterance specifying a first keyword of a multi-keyword phrase from audio data. The method includes, in response to the detecting the first user utterance, monitoring, by the hardware processor, the audio data for a second user utterance specifying a second keyword of the multi-keyword phrase and monitoring sensor data generated by a user attention sensor of the device for an indication of user attention directed to the device. The method includes, in response to detecting the second keyword and detecting the indication of user attention directed to the device, initiating, by the hardware processor, a selected operation of the device.

In one or more examples, a device includes a microphone capable of detecting sound, a user attention sensor capable of detecting user attention directed to the device, and a hardware processor coupled to the microphone and the user attention sensor. The hardware processor is capable of executing operations including detecting, from audio data generated by the microphone, a first user utterance specifying a keyword phrase. The operations include, in response to detecting at least a portion of the keyword phrase, monitoring sensor data generated by the user attention sensor for an indication of user attention directed to the device. The operations include, in response to detecting a remainder of the keyword phrase and detecting the indication of user attention directed to the device, initiating a selected operation of the device.

In one or more examples, a computer program product includes a computer readable storage medium having program instructions embodied therewith. The program instructions are executable by computer hardware, e.g., a hardware processor, to cause the computer hardware to execute operations. The operations include detecting a first user utterance specifying a first keyword of a multi-keyword phrase from audio data. The operations include, in response to the detecting the first user utterance, monitoring the audio data for a second user utterance specifying a second keyword of the multi-keyword phrase. The operations include monitoring sensor data generated by a user attention sensor of the device for an indication of user attention directed to the device. The operations include, in response to detecting the second keyword and detecting the indication of user attention directed to the device, initiating a selected operation of the device.

This Summary section is provided merely to introduce certain concepts and not to identify any key or essential features of the claimed subject matter. Many other features and implementations of the disclosed technology will be apparent from the accompanying drawings and from the following detailed description.

### BRIEF DESCRIPTION OF THE DRAWINGS

The accompanying drawings show one or more implementations of the disclosed technology. The drawings, however, should not be construed to be limiting of the implementations to only the examples shown. Various aspects and advantages will become apparent upon review of the following detailed description and upon reference to the drawings.

FIG. 1 illustrates a computing environment in accordance with one or more implementations of the disclosed technology.

FIG. 2 illustrates a hardware architecture that may be used to implement one or more of the devices illustrated in FIG. 1 in accordance with one or more implementations of the disclosed technology.

FIG. 3 is a method of keyword-based device activation to avoid false positives in accordance with one or more implementations of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to keyword-based device activation and avoiding false positives. In accordance with the implementations described within this disclosure, methods, systems (e.g., devices), and computer program products are provided that are capable of avoiding false positives in devices that use keyword spotting technology. In one or more examples, one or more additional sensors are used in combination with audio and/or sound analysis to ascertain or detect a user's intent to interact with a particular device. The examples are capable of providing on-demand assistance for keyword spotting functionality. Accordingly, the device responds to a detected keyword only in response to detecting the keyword and also affirming or detecting the user's intent to interact with the device that detected the keyword.

Further aspects of the disclosed technology are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

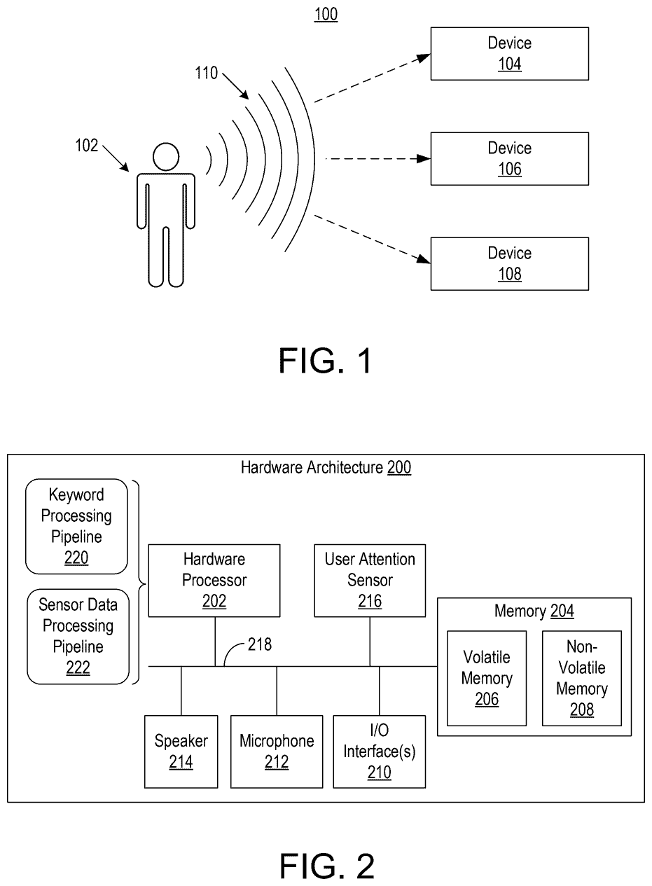

FIG. 1 illustrates an example environment 100 in accordance with one or more implementations of the disclosed technology. In the example of FIG. 1, a user 102 is located proximate to device 104, device 106, and device 108. In the example, user 102 may be located within a predetermined distance of devices 104, 106, and 108 or within a distance such that a microphone of each respective device is capable of detecting user utterances 110 from user 102. For purposes of illustration, each of devices 104, 106, and 108 has keyword spotting enabled and uses the same keyword. In many cases, the particular keyword used for keyword spotting in a device is specified by the manufacturer of the device and may not be changeable by the user. In this regard, in cases where user 102 owns multiple devices from the same manufacturer, there is a higher likelihood that each of the devices responds to the same keyword for keyword spotting. In some cases, devices belonging to multiple different users may all respond to a same keyword as well.

The implementations described herein prevent a device from responding to a user utterance in cases where the user is not directing attention to the device. The implementations are capable of reducing false positives in cases where user 102 is co-located with a single device capable of detecting user utterances and that has keyword spotting enabled. The implementations also may be used in cases where user 102 is co-located with two or more devices each capable of detecting user utterances where each device has keyword spotting enabled and responds to, or uses, the same keyword for keyword spotting. In this regard, the two or more devices may or may not belong to a same user. In the example, the particular number of devices shown is for purposes of illustration and not limitation.

With keyword spotting enabled, each of devices 104, 106, and 108 is continuously detecting sound and monitoring for the occurrence of the same keyword. Typically, each of devices 104, 106, and 108 includes a hardware processor that is capable of performing operations such as speech recognition to detect the keyword in user utterances detected by a microphone of the respective device.

In a typical implementation, keyword spotting utilizes a multi-keyword phrase to activate a device. In general, use of a multi-keyword phrase requires the device to detect each word of the multi-keyword phrase in order before responding to the user utterance. In the case of a two-word multi-keyword phrase, the device must detect both the first keyword followed by the second keyword of the multi-keyword phrase in the specified order before implementing a response.

For purposes of illustration and discussion, the device that the user is intending to interact with is device 106 and is also referred to as the “intended device.” Devices 104 and 108 are devices that the user does not intend to interact with and are referred to as unintended devices. In the example, user 102 may utter a first user utterance of user utterances 110 specifying a first keyword of the multi-keyword phrase. In doing so, each of devices 104, 106, and 108 may detect the first keyword and continue to monitor for the second keyword of the multi-keyword phrase.

In one or more examples, one or more or all of devices 104, 106, and 108 is capable of enabling a user attention sensor that is operable as an attention sensor included in, or coupled to, the respective device(s). The user attention sensor captures sensor data that may be processed by the hardware processor of the respective device to detect whether user 102, at or about the time of uttering the first keyword and/or second keyword of the multi-keyword phrase, is directing attention to the device.

In one or more examples, only in response to detecting the first keyword of the multi-keyword phrase, the second keyword of the multi-keyword phrase, and detecting that user 102 directed attention to the device will the device respond to the multi-keyword phrase. In the example of FIG. 1, because the user directed attention to device 106 while uttering the multi-keyword phrase and not to device 104 or to device 108, only device 106 will respond. Devices 104 and 108 may continue in their current operating state and take no action (e.g., not respond) to the multi-keyword phrase.

A variety of different types of devices are capable of operating in a low power mode while monitoring for at least a first keyword of a multi-keyword phrase. For example, such devices may include one or more low power ICs or IC subsystems that are capable of digitizing received audio into audio data and analyzing the audio data for one or more keywords without requiring significant power. Such component(s) may be operative while other components are not operative or power to other components is reduced or turned off. Thus, the unintended devices, if operating in the low power mode, may continue to do so without exiting the low power mode thereby conserving power.

In various examples described herein, the keyword phrase is described as being detected in terms of different words. In one or more other examples, the keyword phrase may be detected in portions such as by detecting a portion of the keyword phrase (e.g., a first portion) and detecting a remainder of the keyword phrase. In some examples, the portion first detected may correspond to a word. In other examples, the portion first detected may be a formative (e.g., a syllable or portion of a word) or a word and at least one additional formative (e.g., portion of a next word of the keyword phrase). Accordingly, the remainder of the keyword phrase is the remaining portion of the keyword phrase, whether a formative, a word, or a word and one or more formatives, may be detected.

FIG. 2 illustrates a hardware architecture (architecture) 200 that may be used to implement any of the devices 104, 106, and/or 108 illustrated in FIG. 1 in accordance with one or more implementations of the disclosed technology. Architecture 200 may be used to implement a data processing system. A “data processing system” refers to one or more hardware systems capable of processing data. Each hardware system may include one or more hardware processors and memory.

Architecture 200 includes one or more hardware processors illustrated as hardware processor 202. Hardware processor 202 is implemented as circuitry that is capable of executing computer-readable program instructions (program instructions). The circuit(s) may comprise integrated circuits (ICs) or may be embedded within an IC.

In one or more examples, hardware processor 202 may be embodied as a central processing unit (CPU). Hardware processor 202 may include one or more cores, for example, where each core is capable of executing program instructions. Hardware processor 202 may be implemented using any of a variety of architectures such as, for example, a complex instruction set computer architecture (CISC), a reduced instruction set computer architecture (RISC), a vector processing architecture, or other known architectures. For example, a hardware processor may be implemented using an x86 architecture (e.g., IA-32, IA-64), a Power Architecture, as an ARM processor, or the like. Hardware processor 202 is capable of executing or initiating one or more or all of the operations described herein.

In one or more examples, hardware processor 202 may include one or more co-processors (not shown). Each co-processor may be implemented as an application-specific IC (ASIC) or core that is dedicated to performing particular processing tasks such as audio processing and/or image processing. In one or more examples, the co-processor may be implemented as a digital signal processor (DSP) circuit block, an audio codec, an image processor, or the like that is capable of implementing one or more or all of the operations described herein.

In the example of FIG. 1, the co-processor, or co-processors as the case may be, may be implemented on a same die or implemented as separate dies or chiplets that are interconnected within a single package. In one or more other examples, the co-processor, or co-processors as the case may be, may be implemented as separate or discrete IC devices coupled through suitable interconnect circuitry which may be, or include, bus 218.

Architecture 200 can include memory 204. Memory 204 may be embodied as one or more computer-readable storage mediums. Memory 204 may include a volatile memory 206 and a non-volatile memory 208. Volatile memory 206 may be embodied as random-access memory (RAM) and may include cache memory. Volatile memory 206 may be referred to as “runtime memory.” Non-volatile memory 208 may include a non-volatile magnetic medium and/or a solid-state medium (typically called a “hard drive”). Non-volatile memory 208 also may include one or more disk drives capable of reading from and writing to various types of removable, non-volatile mediums such as a removable, non-volatile magnetic disk (e.g., a “floppy disk”) and/or a removable, non-volatile optical disk such as a CD-ROM, DVD-ROM or other optical media.

Memory 204 is capable of storing program instructions and/or data such that hardware processor 202 (and/or any co-processor(s) thereof) is/are capable of executing the program instructions to perform one or more operations as described within this disclosure. For example, the program instructions can include an operating system, one or more application programs, other program code such as an audio driver, and program data. The program instructions also may implement a keyword processing pipeline 220 and a sensor data processing pipeline 222. Hardware processor 202, in executing the computer-readable program instructions, is capable of performing the various operations described herein that are attributable to a computer.

Architecture 200 may include one or more Input/Output (I/O) interfaces 210. I/O interface(s) 210 allow architecture 200 to communicate with one or more external devices and/or communicate over one or more networks such as a local area network (LAN), a wide area network (WAN), and/or a public network (e.g., the Internet). Examples of I/O interfaces 210 may include, but are not limited to, network cards, modems, network adapters (whether wired and/or wireless), hardware controllers, etc. Examples of external devices also may include devices that allow a user to interact with architecture 200 (e.g., a display, a keyboard, and/or a pointing device) and/or other devices such as an accelerator card.

Architecture 200 may include a microphone 212 (e.g., an input audio transducer capable of detecting and capturing sound) and optionally a speaker 214 (e.g., an output audio transducer capable of generating sound) to facilitate voice-enabled functions, such as voice recognition, digital recording, telephony functions, and the like. Microphone 212, or other transducer circuit capable of detecting sound waves, is capable of generating audio data (e.g., digital audio data as sampled from an output of microphone 212). The audio data may be analyzed to detect one or more keywords of a multi-keyword phrase therein for purposes of keyword spotting. Speaker 214 may play audio as sound to a user.

In one or more examples, keyword processing pipeline 220 may implement a speech recognition engine executable by hardware processor 202. As such, keyword processing pipeline 220 is capable of recognizing the keyword from audio data generated by microphone 212 from user utterances. Keyword processing pipeline 220 may be implemented as a machine learning model trained to detect keywords of a multi-keyword phrase.

Architecture 200 may include a user attention sensor 216. User attention sensor 216 may be implemented as any of a variety of different sensors that may be used to detect user attention. In one or more examples, user attention may be detected based on detecting facial features of a user. In some examples, user attention sensor 216 is capable of generating image data (e.g., digital image data such as one or more image frames). An example of user attention sensor 216 includes, but is not limited to, any of a variety of optical sensors. Examples of optical sensors may include, but are not limited to, a red-green-blue (RGB) camera, a camera sensor, an infrared (IR) camera, and/or an IR sensor.

In one or more examples, sensor data processing pipeline 222 may implement one or more sensor data processing functions executable by hardware processor 202. Sensor data processing pipeline 222, for example, is capable of detecting particular features in sensor data. In one or more examples, the sensor data includes image data, e.g., image frame(s). In such examples, sensor data processing pipeline 222 is capable of performing image processing to detect features from the sensor (e.g., image) data indicating that user 102 directed attention to a particular device. Sensor data processing pipeline 222 may be implemented as a machine learning model trained to detect one or more features as described in greater detail hereinbelow that indicate user 102 directed attention to the particular device in which sensor data processing pipeline 222 is disposed.

In one or more other examples, each processing pipeline illustrated may execute in a different co-processor circuit block of hardware processor 202 or as a separate co-processor that exists as a discrete component relative to hardware processor 202. Each such co-processor may be placed in an inactive or low power mode when not in use and activated or enabled as needed.

Bus 218 represents one or more of any of a variety of communication bus structures. By way of example, and not limitation, bus 218 may be implemented as a Peripheral Component Interconnect Express (PCIe) bus. Bus 218 is capable of coupling to each of hardware processor 202 (and/or any co-processors), memory 204, I/O interfaces 210, microphone 212, speaker 214, and user attention sensor 216. The respective devices coupled to bus 218 may be coupled through respective interface circuitry. Bus 218 may represent a plurality of buses and/or interconnect circuitry that may be interconnected and/or hierarchically organized.

In one or more other examples, the various components of architecture 200 shown to couple to bus 218 couple or attach thereto via suitable interface circuitry such as bus interfaces. For purposes of illustration, the interface circuitry through which microphone 212 couples to bus 218 can include analog-to-digital (A/D) converter circuitry that supports a sampling rate suitable for recognizing user speech as is known in the art. Accordingly, microphone 212, by way of the interface circuitry, is capable of outputting audio data for detected sounds to hardware processor 202.

The interface circuitry through which speaker 214 couples to bus 218 can include digital-to-analog (D/A) converter circuitry and amplification circuitry suitable to drive speaker 214 as is known in the art. Accordingly, speaker 214, by way of the interface circuitry, is capable of outputting audio data as sound.

In one or more other examples, the A/D converter circuitry and/or D/A converter circuitry may be incorporated into each of the respective sensors.

Architecture 200 is only one example of a hardware architecture for a device and is not intended to suggest any limitation as to the scope of use or functionality of example implementations described herein. Architecture 200 is an example of computer hardware that is capable of performing the various operations described within this disclosure. In this regard, architecture 200 may include fewer components than shown or additional components not illustrated in FIG. 2 depending upon the particular type of device and/or system that is implemented. The particular operating system and/or application(s) included may vary according to device and/or system type as may the types of I/O devices included.

In one or more examples, one or more of the illustrative components may be incorporated into, or otherwise form a portion of, another component. For example, a processor may include at least some memory. As noted, hardware processor 202 may include one or more co-processors. For example, hardware processor 202 and any co-processor(s) may be incorporated into a single IC whether disposed on a same die or implemented as a plurality of interconnected dies or chiplets disposed in a same package as part of a multi-die IC. In other examples, as noted, any co-processors may be implemented as separate or discrete components from hardware processor 202.

Examples of devices and/or systems that may be implemented using a hardware architecture as illustrated in FIG. 2 can include one or more of a workstation, a desktop computer, a computer terminal, a mobile computer, a laptop computer, a netbook computer, a tablet computer, a smart phone, a personal digital assistant, a smart-speaker, a smart watch, smart glasses, a gaming device, a set-top box, a smart television, information appliance, Internet-of-Things (IoT) device, server, a virtual reality (VR) system, an augmented reality (AR) system, a mixed reality (MR) system, an extended reality (XR) system, a metaverse system, or the like.

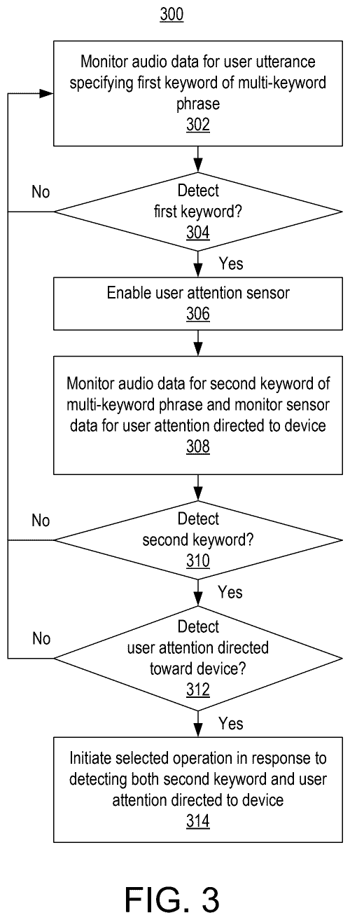

FIG. 3 is a method 300 of keyword-based device activation to avoid false positives in accordance with one or more implementations of the disclosed technology. Method 300 may be implemented by a device such as device 106 having a hardware architecture as described in connection with FIG. 2. Method 300 may be performed in real-time. Further, method 300 may begin in a state where device 106 has keyword spotting enabled and, as such, is continuously converting sound to audio data and checking the audio data to detect keyword(s).

In one or more examples, device 106 may operate in a normal operating mode. In one or more other examples, device 106 may operate in a low power mode where hardware processor 202 (e.g., portions of hardware processor 202) and/or other components of device 106 are in a low power mode. In either case, hardware processor 202 or, for example, a portion thereof such as a co-processor, is operative to execute keyword processing pipeline 220 and perform speech recognition.

In block 302, device 106 is capable of monitoring audio data for a user utterance specifying a first keyword of a multi-keyword phrase. For purposes of illustration, consider an example in which the multi-keyword phrase is “turn on.” In block 302, hardware processor 202 is capable of monitoring for an occurrence of the word “turn” within the audio data. For example, keyword processing pipeline 220, as executed by hardware processor 202, is capable of processing audio data obtained from microphone 212 to recognize, or detect, the first keyword. In one or more examples, a first portion of the keyword phrase may be detected.

In block 304, in response to detecting the first keyword, method 300 continues to block 306. In response to not detecting the first keyword, method 300 may loop back to block 302 to continue iterating until such time that the first keyword is detected.

In block 306, in response to detecting the first keyword, hardware processor 202 is capable of enabling user attention sensor 216. For example, at least initially upon activating keyword spotting in device 106, user attention sensor 216 is placed in a disabled state. In one example, in the disabled state, user attention sensor 216 is powered off or in a low power mode such that user attention sensor 216 is not capturing data and not generating sensor data such as image data and/or other data. For example, device 106 may be in a sleep state (e.g., the S0i3 Power Saving Mode or other low power or sleep state). In that case, only limited functions may be operable such as those necessary to monitor audio data for one or more keywords that cause the device to awaken (e.g., implement Wake Word Detection or Wake on Voice functionality). In that case, user attention sensor 216, which may initially be powered down, may be powered on in block 306 and activated. In another example, user attention sensor 216 may be powered on (e.g., not in a low power mode), but still not capturing data and not generating data.

In block 306, hardware processor 202 enables user attention sensor 216 which may include powering on user attention sensor 216 if not already powered on and/or exiting user attention sensor 216 from a low power state if placed in such a low power state. In block 306, as part of enabling user attention sensor 216, hardware processor 202 also causes user attention sensor 216 to begin operation to capture sensor data. For example, in response to detecting the first keyword, user attention sensor 216 begins generating sensor data. In one or more examples, user attention sensor 216 begins capturing one or more images and begins generating image data. For example, user attention sensor 216, in block 306, is capable of generating one or more, e.g., N, image frames of image data where N is an integer value of 1 or more.

In one or more examples, user attention sensor 216 may be positioned in device 106 to capture image data for a field of view that includes a location at which a user would typically be positioned when using or attempting to access device 106. As an illustrative and non-limiting example, in the case where device 106 is a laptop computer or a tablet computer, user attention sensor 216 may be positioned to face outward from the screen or display of the device. In the case where device 106 is a smart appliance such as a smart speaker, user attention sensor 216 may be facing out into a room or other environment in which the smart speaker is being used (away from a wall). In one or more other examples, device 106 may include multiple user attention sensors 216 each having a different field of view to provide device 106 with the ability to detect users in and around device 106. In some examples, the user attention sensors 216 may provide an increased field of view, e.g., a 360-degree field of view, around device 106.

In block 308, also in response to detecting the first keyword, hardware processor 202 is capable of monitoring audio data for a user utterance specifying the second keyword of the multi-keyword phrase. In block 308, keyword processing pipeline 220 is capable of processing the audio data to detect the word “on.” In the example of FIG. 3, blocks 306 and 308 may be implemented concurrently.

In block 308, also in response to detecting the first keyword, hardware processor 202 is capable of monitoring the sensor data output from user attention sensor 216 to detect an indication of user attention directed to device 106. For example, the sensor data may be image data processed through sensor data processing pipeline 222 to detect user attention. User attention directed to a particular device may such as device 106 in this example may be detected based on the detection of one or more different features within the image data.

In one or more examples, device 106 is capable of detecting, from the image data, body position of user 102 in relation to device 106. Depending on the particular type of device, user 102, when attempting to interact with the device, may be expected to take on or have a particular body position (e.g., or posture). In this case, an example of an indication that the user is directing attention to device 106 is detecting that the body position of user 102 matches one or more predetermined body positions. For example, sensor data processing pipeline 222 may be trained to detect one or more predetermined body positions of user 102 from the image data. An example of a body position for user 102 in using a laptop or tablet computer is the user facing device 106. In this example, sensor data processing pipeline 222 may detect features such as a silhouette of the user to detect positioning of shoulders or other parts of the body of user 102 that indicate that the user is facing toward device 106 (e.g., facing user attention sensor 216).

In one or more examples, device 106 is capable of detecting, from the image data, head position of user 102 in relation to device 106. For example, sensor data processing pipeline 222 may be trained to detect a head position from the image data indicating that the user is facing device 106 or that the head of user 102 is oriented toward device 106. In this case, an example of an indication that user 102 is directing attention to device 106 is detecting that the orientation of the head of user 102 is facing or oriented in the direction of device 106. For example, sensor data processing pipeline 222 detects that the face of user 102 is facing toward device 106 based on head orientation.

In one or more examples, device 106 is capable of detecting, from the image data, one or more facial features of user 102 in relation to device 106. For example, sensor data processing pipeline 222 may be trained to detect one or more facial features of user 102 (e.g., eyes, nose, mouth, etc.) which indicate that the face of the user is directed toward device 106. In this case, an example of an indication that user 102 is directing attention to device 106 is detecting one or more facial features of user 102, which indicates that the face of user 102 is facing or oriented in the direction of device 106 (e.g., facing user attention sensor 216).

In one or more examples, device 106 is capable of detecting, from the image data, a direction of eye gaze of user 102 in relation to device 106. For example, sensor data processing pipeline 222 may be trained to detect pupils of user 102 and a trajectory for eye gaze of user 102. In this case, an example of an indication that user 102 is directing attention to device 106 is detecting that an eye or eyes of user 102 is/are looking at device 106 based on the determined trajectory. For example, device 106 detects the pupil(s) of user 102 and estimates the trajectory of eye gaze of user 102. A trajectory directed toward device 106 or to a location within a predetermined vicinity or range of device 106 indicates that user 102 is directing attention to device 106.

Detecting user attention using any of the one or more techniques described within this disclosure indicates that user 102 has an intent to interact with device 106 (e.g., as directed attention to device 106). In one or more examples, for example, sensor data processing pipeline 222 is capable of outputting a binary decision indicating whether user attention was detected in response to detecting one or more of the aforementioned indicators.

In block 310, hardware processor 202 determines whether the second keyword has been detected. In an example implementation, hardware processor 202 determines whether a remainder of the keyword phrase has been detected. For example, hardware processor 202, in processing further audio data through keyword processing pipeline 220, determines whether the second keyword, e.g., “on” in this case, has been detected. In response to detecting the second keyword of the multi-keyword phrase, method 300 continues to block 312. In response to not detecting the second keyword of the multi-keyword phrase, method 300 loops back to block 302 to begin monitoring for the first keyword anew.

In one or more examples, hardware processor 202 may use a predetermined window of time for detecting the second keyword. That is, hardware processor 202 may continue processing audio through keyword processing pipeline 220 following detection of the first keyword for a predetermined amount of time referred to as the window of time to detect the second keyword. The second keyword must be detected within this window of time otherwise method 300 loops back to block 302 to start the keyword spotting function anew with monitoring for the first keyword.

In block 312, hardware processor 202 is capable of determining whether user attention directed toward the device (e.g., device 106 in this case) has been detected. In response to detecting user attention directed to device 106, method 300 continues to block 314. In response to not detecting user attention directed to device 106, method 300 loops back to block 302 to continue processing and start keyword spotting anew with monitoring for the first keyword.

In one or more examples, user attention sensor 216 may remain enabled for the duration of the window of time and continue to generate image data for the duration of the window of time. In one or more other examples, user attention sensor 216 may be disabled upon expiration or the ending of the window of time such that user attention sensor 216 stops generating sensor data and may be returned to the operating state that existed for user attention sensor 216 prior to block 306. In one or more examples, detection of the second keyword prior to the expiration of the window of time may be considered an ending of the window of time thereby causing user attention sensor 216 to be disabled as described. In any case, attention of user 102 directed to device 106 may be detected based on any sensor data collected during the window of time whether the window of time expires or is ended as described. In the case where the second keyword is not detected within the window of time, user attention sensor 216 still may be disabled as discussed above.

In one or more other examples, a second window of time that is distinct from the prior mentioned window of time may be used for purposes of user attention sensor 216. The second window of time may be for the same amount of time as the prior mentioned window or for a different amount of time, e.g., a longer amount of time such as an additional second or more, as the prior mentioned window of time. In this example, user attention sensor 216 may remain enabled for the duration of the second window of time and continue to generate image data for the duration of the second window of time. User attention sensor 216 may be disabled upon expiration or the ending of the second window of time such that user attention sensor 216 stops generating sensor data and may be returned to the operating state that existed for user attention sensor 216 prior to block 306.

In block 314, hardware processor 202 is capable of initiating a selected operation in response to detecting both the second keyword of the multi-keyword phrase and detecting user attention directed to device 106. The selected operation may be any type of operation executable by device 106. In one or more examples, the selected operation may be to wake device 106 in the case where one or more components of device 106 are operating in a low power mode. In one or more examples, the selected operation may include listening for a predetermined amount of time for another user utterance specifying a voice command.

By requiring detection of each keyword of a multi-keyword phrase and detection of user attention directed to the device, the implementations described herein avoid false positives where the user may utter the multi-keyword phrase but not provide any attention to any particular device. In such cases, the implementations prevent the device from responding and, in cases where the device is in a low power mode, prevent the device from expending additional power unnecessarily by waking the device or exiting the device from the low power mode in cases where the user did not intend on interacting with the device. This can conserve energy, which may be particularly beneficial for battery powered devices. This also prevents unintended devices from erroneously responding to user voice commands.

The terminology used herein is for the purpose of describing particular examples only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium includes an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the implementations described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the implementations described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the implementations described herein.

Certain aspects of the implementations are described herein with reference to flowchart illustrations and/or block diagrams of methods, devices, apparatus, systems, and computer program products. It will be understood that one or more blocks or in some cases each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the implementations described. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various implementations of the disclosed technology have been presented for purposes of illustration, but are not intended to be exhaustive or limited to the examples disclosed. Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

What is claimed is:

1. A method of activating a device, comprising:
detecting, by a hardware processor of the device, a first user utterance specifying a first keyword of a multi-keyword phrase from audio data;
in response to the detecting the first user utterance,
monitoring, by the hardware processor, the audio data for a second user utterance specifying a second keyword of the multi-keyword phrase; and
monitoring sensor data generated by a user attention sensor of the device for an indication of user attention directed to the device; and
in response to detecting the second keyword and detecting the indication of user attention directed to the device, initiating, by the hardware processor, a selected operation of the device.

2. The method of claim 1, further comprising:
in response to detecting the first keyword, activating the user attention sensor of the device.

3. The method of claim 1, wherein the detecting the attention of the user comprises detecting a body position of the user that matches a predetermined body position.

4. The method of claim 1, wherein the detecting the attention of the user comprises detecting at least one of a head orientation or a face of the user facing toward the device.

5. The method of claim 1, wherein the detecting the attention of the user comprises detecting that an eye gaze of the user is directed toward the device.

6. The method of claim 1, wherein the user attention sensor is a red-green-blue (RGB) camera.

7. The method of claim 6, wherein the user attention sensor is an infrared camera.

8. The method of claim 1, wherein the selected operation includes waking the device from a low power mode.

9. The method of claim 1, wherein the selected operation includes responding to a further user utterance specifying a command.

10. A device, comprising:
a microphone capable of detecting sound;
a user attention sensor capable of detecting user attention directed to the device; and
a hardware processor coupled to the microphone and the user attention sensor, wherein the hardware processor is capable of executing operations including:
detecting, from audio data generated by the microphone, a first user utterance specifying a keyword phrase;
in response to detecting at least a portion of the keyword phrase, monitoring sensor data generated by the user attention sensor for an indication of user attention directed to the device; and
in response to detecting a remainder of the keyword phrase and detecting the indication of user attention directed to the device, initiating a selected operation of the device.

11. The device of claim 10, wherein the hardware processor is capable of executing operations further comprising:
in response to detecting at least the portion of the keyword phrase, activating the user attention sensor of the device.

12. The device of claim 10, wherein the detecting the attention of the user comprises detecting a body position of the user that matches a predetermined body position.

13. The device of claim 10, wherein the detecting the attention of the user comprises detecting at least one of a head orientation or a face of the user facing toward the device.

14. The device of claim 10, wherein the detecting the attention of the user comprises detecting that an eye gaze of the user is directed toward the device.

15. The device of claim 10, wherein the user attention sensor is a red-green-blue (RGB) camera.

16. The device of claim 15, wherein the user attention sensor is an infrared camera.

17. The device of claim 10, wherein the selected operation includes waking the device from a low power mode.

18. The device of claim 10, wherein the selected operation includes responding to a further user utterance specifying a command.

19. A computer program product comprising a computer readable storage medium having program instructions embodied therewith, wherein the program instructions are executable by computer hardware of a device to cause the computer hardware to execute operations comprising:
detecting a first user utterance specifying a first keyword of a multi-keyword phrase from audio data;
in response to the detecting the first user utterance, monitoring the audio data for a second user utterance specifying a second keyword of the multi-keyword phrase;
monitoring sensor data generated by a user attention sensor of the device for an indication of user attention directed to the device; and
in response to detecting the second keyword and detecting the indication of user attention directed to the device, initiating a selected operation of the device.

20. The computer program product of claim 19, wherein the program instructions are executable by the computer hardware to execute operations further comprising:
in response to detecting the first keyword, activating the user attention sensor of the device.
